(19) United States
(12) Patent Application Publication
(10) Pub. No.: US 2008/0047307 A1
(43) Pub. Date: Feb. 28, 2008

(54) Restraint Device

(76) Inventor: Daniel Kenney, Woodinville, WA (US)

Correspondence Address: VANTAGE LAW PLLC, 355 NW GILMAN BLVD., SUITE 203, ISSAQUAH, WA, 98027, US

(21) Appl. No.: 11/467,550

(22) Filed: Aug. 26, 2006

(51) Int. Cl. E05B 75/00

(52) U.S. Cl. 70/16

(57) ABSTRACT

The invention is a personal restraint or tagging device utilized to restrain an individual as well as provide a secure means for the transfer of digital data within the restraint device itself. The device includes a reusable central body that has mechanical structure for holding two individual single-use flexible restraints while, at the same time, providing a housing for a flash memory or equivalent electronic memory storage device that stores digital data pertinent to the arrest and subsequent incarceration of an individual. An additional removable device connects to the central hub and allows for the reading and writing of stored data using a conventional computing device. The described device may also be used with a single flexible restraint to affix the device to a piece of evidence or as an identification and memory tag on objects requiring storage of information.

### TECHNICAL FIELD

The disclosed invention relates to personal restraint devices such as handcuffs or leg restraints. In particular, it relates to a handcuff restraint system (“handcuffs”) that contains a rewritable data storage device embedded within a reusable central module of the handcuffs that is combined with single-use, disposable wrist restraints.

### BACKGROUND OF THE INVENTION

Law enforcement, security, and military personnel have used flexible, single-use restraints for many years as a low-cost, lightweight alternative to metal handcuffs. The ability for a single person to carry multiple sets of restraints in a volatile environment such as a riot situation or in urban combat operations is a distinct advantage when processing or transporting arrested or detained suspects.

The construction of a typical single-use, dual-cuff, flexible restraint is simple and effective. For reference purposes, an example of this type of flexible restraint is illustrated in U.S. Pat. No. 4,910,831. A band of flexible plastic is curved around in a circle so that the end of the band passes back through a slot in the central portion of the restraint. Within the slot are angled pawls that catch and lock into grooves molded into the inner surface of the flexible band. The grooves and pawls are designed to allow the band to be drawn in one direction, but prevent the band from moving in the opposite direction. Therefore, by pulling the end of the flexible band through the central hub, the circle of the restraint may be drawn tighter, around a wrist or ankle, while the pawl system permanently prevents the band from releasing. The only way to release the restraint is to cut the band.

The present invention may appear, on the outset, to bear a resemblance to the flexible restraint described above. However, the present invention has design improvements that are intended to provide a more secure and humane method of restraint, along with a better way of providing and processing information about the person or suspect held by the restraint.

### SUMMARY OF THE INVENTION

The design described here provides two kinds of improvements over known prior designs. The first improvement relates to the physical design of the restraint described here. In prior double-cuff systems, releasing a suspect or prisoner from the restraint involved cutting one side or the other of the flexible loops surrounding a wrist (or ankle, as the case may be). The entire cuff is rendered unusable when this is done (because both loops are integrated together as a single restraint)—which means that an entirely new double cuff must be placed on the suspect or prisoner to restrain him once again.

The present design connects two independent restraints (or flexible loops) together by using a central hub. The hub allows one loop to be cut while still keeping the hub and other loop connected to a limb, if desired. This may be desired on a temporary basis when it is needed to move the restrained person, or for other administrative purposes, like taking fingerprints or the like. To re-cuff the individual, the hub allows the cut loop to be replaced easily while leaving the other one alone. Thus, only one loop needs to be replaced and not the entire two-loop unit, as is the case with prior designs.

The second improvement relates to the fact that there is an ever-increasing amount of supporting documentation accumulated during the arrest and subsequent detention of an individual. This documentation generally includes incident or arrest forms, witness statements, audio and video records, photographs of the crime scene and suspect, as well as biometric information and other forms of evidence. Certain kinds of intense events, such as prisoner transport, riot or combat operations increases the likelihood that documented information of this kind will become damaged, lost, or confused among different prisoners. The improved design described here provides a secure and reliable way to accumulate and transport data with the prisoner while reducing opportunities for damage, loss, or confusion.

With respect to the first improvement described above, a reusable central body or hub has two socket-like openings, each one shaped to receive the “pawl” end of a flexible loop or band. The “pawl” end is inserted into the socket so that the slot in the “pawl end” (which captures the end of the loop) comes into registration with slots in the sidewalls of the hub that are on opposite sides of the socket. This defines an open or line-of-sight passageway all the through the body of the hub and through the “pawl” end of the loop, when the “pawl end” is inserted in the hub. The end of the loop can then be inserted and extended through this passageway from one side of the hub until it extends out and from the other. At the same time, the “pawl” end of the loop captures the loop's end in conventional fashion. However, because the end of the loop is also running through wall structure when this connection is made, the loop cannot be disconnected from the hub until the loop is cut and the cut end of the loop is pulled out and away from the hub.

The other loop is connected to the hub in the same way. However, it is independent and can be connected and removed from the hub as a single loop. As a consequence, it is possible to free a prisoner's hands (or feet) temporarily, if desired by cutting one replaceable loop while leaving the other loop (and hub) attached to the prisoner's other limb. Then, only the loop that was cut needs to be replaced. The uncut loop and hub stay on place,

With respect to the second improvement, the design described here includes a rewritable electronic storage device stored within the body of the central hub. The storage device allows for the storage and transport of any form of electronic data (i.e. arrest forms, audio & video files, biometric data, etc.) that may be applicable to the restrained person or prisoner in a manner that is fixed to and travels with the prisoner, because it travels with the prisoner as part of the restraining device. In a typical application, information relating to the arrest and subsequent incarceration of the restrained person would be gathered by the arresting officer and downloaded directly into the restraint device. The device would then accompany the arrested individual throughout transport, booking, and incarceration and allow for immediate access to the electronic records at any time, during or after transport, or at the final incarceration point for the individual.

The flexibility of the above design enables it to be used as a tagging device for evidence or the like. For example, the hub and one loop could be attached to a person or object for the purpose of identifying the person or object, and providing an affixed data storage module for the storage and transfer of digital data along with the person or object. In this described improvement, a single loop would attach the device to an object (i.e. through the locking hasp of a case).

The central hub is designed to be watertight, impact and vibration resistant and stand up to years of field operations with no degradation in usability. The single-use restraints are commercially available and are utilized only as part of the system Further details of the invention as summarized above are disclosed in the following description which refers to the attached drawings.

### BRIEF DESCRIPTION OF THE DRAWINGS

Like reference numerals and letters refer to like parts throughout the various views, unless indicated otherwise, and wherein:

FIG. 1 is a pictorial view of a restraint device constructed in accordance with the invention;

FIG. 2 is an exploded view of the restraint device shown in FIG. 1;

FIG. 3 is a pictorial view of the data cable adapter;

FIG. 4. Is an exploded view of the data cable adapter,

FIG. 5 is a pictorial view of the restraint device in FIG. 1 showing the attachment of a data connector in accordance with the best mode description;

FIG. 6 is a chart showing the best mode of data flow in a conventional use of the device shown in FIG. 1; and

FIG. 7 is a pictorial view of the restraint device used as an evidence or door tag.

### BEST MODE FOR CARRYING OUT THE INVENTION

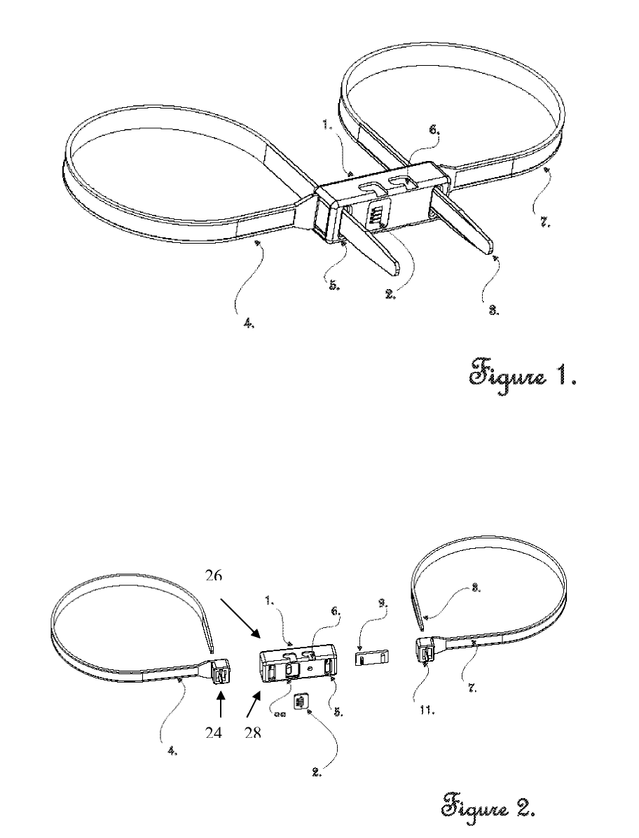

Referring to FIG. 1 in the drawings, a handcuff device 10 is shown in accordance with the present best mode for carrying out the invention. Similar to existing double cuff restraints, the device 10 contains two loops of flexible material 4,7. However, differing from existing designs, the two loops 4,7 are independent of each other. The device 10 also contains a central hub 1, manufactured from a heat-treated aluminum extrusion, that connects the loops 4,7 together.

The loops of flexible material 4,7 are typical of commercially available single cuff flexible restraints in that they contain a locking head 11 (see FIG. 2), or “pawl” end, that contains pawls or cams that interface with grooves molded into the inside face of the flexible band 7. A tapered end 3 on the flexible restraint allows the tip of the restraint to pass through the slot 24 in the locking head 11 of the restraint and interface with the locking cams or pawls located inside of the locking head 11. This type of connection is well known and used in many different kinds of applications.

Referring now to FIG. 2, the cuff 10 is separable into three distinct components. The first component is one flexible loop 4, as described above, located on the left hand side of the device. The second component is the central hub 1, or housing, that provides integrating structure to the assembled device 10, as well as a housing for a data memory module 9 and surface contact connector board 2. The third component is the second flexible loop 7 located on the right hand side of the device.

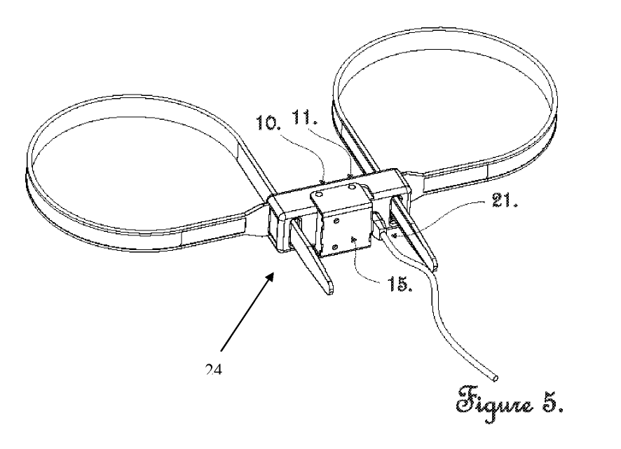

Each flexible loop 4,7 is inserted into the central hub 1 via an axial access opening, or “socket,” in the end of the central hub 1. The slot 24 in the head or pawl end of the flexible loop 11 aligns with slots 26, 28 (see FIG. 2) located through the front and back of the central hub 1, the general location of both hub slots being generally indicated by 5. The end 3 of each flexible loop is bent around behind the central hub 1 and passed through the slot 26 on the backside of the central hub 1. The end 3 is then pushed through the locking head 11 of the flexible restraint and out through the slot 28 on the opposite side (see, e.g., FIGS. 1 and 5). At this point the central hub 1 irreversibly captures the flexible loop 4,7 and prevents the loop from separating from the central hub 1. The process for inserting the flexible loop into the central hub 1 is identical for each loop 4,7 Once installed, the loops 4, 7 cannot be removed from the central hub 1 without cutting or destroying them. Obviously, the loops need to be replaced when cut, but the hub 1 is reusable.

The central hub 1 serves a multitude of purposes. First, it provides a means for combining the flexible loops 4,7 into an integrated dual-loop or double-cuff system. Second, it houses a data memory module 9. Third, it has an electronic patch connector board 2 that is permanently bonded to the data memory module both mechanically and electrically via a pin-style soldered connection that passes through an opening 22 in the front face of the central hub 1.

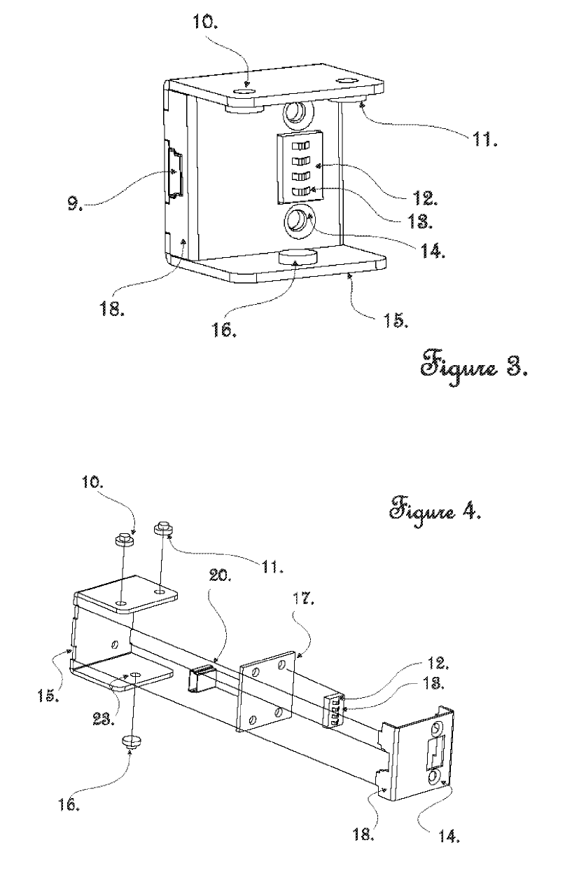

The electronic patch connector board 2 provides a sealed solution so that a spring pin connector 12 in a separate cable adapter module (FIG. 3) may interface with the electronic terminals, within the data memory module 9, required to read and write electronic data to the data memory module 9. It should be appreciated that it may be possible to read and write data wirelessly through some form of conventional wireless means or by use of RFID technology, the implementation of which is well-known.

The data storage module 9 is fully encapsulated with epoxy or a similar waterproof potting compound. Lastly, the central hub 1 has a “J-Groove” three-point retention mechanism 6 so that a separate cable adapter module (FIG. 3) may be temporarily affixed to the central hub 1 for the purposes of reading to and writing from the data storage module 9 using a standard computing device. This operation is further described in detail below.

The data storage module 9 is based on standard USB flash memory devices commonly available in the commercial market. This type of storage device allows any USB-host capable computing device to read from and write to the data storage module using software integral to the operating system of the computing device. A USB flash memory module requires four data pins for operation. These pins are +5v DC power, Ground, transmit communication, and receive communication. The memory data module for use in the device 10 described here differs from conventional USB flash memory modules in that a custom connector is fitted to the memory device, which allows the use of the surface contact patch board 2, thereby improving the durability and strength of the device when compared to conventional USB rectangular-style connectors. It should be noted that USB flash memory modules were chosen for the best implementation, but are by no means the sole method or technology by which data may be stored within the described invention. Other standard memory types such as RFID or random access memory (RAM) may be used. USB was selected for the broad acceptance of the protocol.

FIG. 4 illustrates the current best method for combining the physical requirements of the mechanical system with the electrical requirements of both the memory storage module 9 and the computing device. In the cable adapter device 15, a “c” shaped channel is formed from sheet steel. This channel serves as the primary structure for the cable adapter device. Two threaded holes 10, 11 are located on the top surface of the c-channel 15, perpendicular to the top surface and in plane with each other (in reference to the back surface of the c-channel). A third threaded hole 23 is located on the bottom surface of the c-channel in the same plane referenced for the two holes located in the top surface. Threaded into these holes are plastic retaining pins that extend from the top and bottom surfaces of the c-channel inward towards each other. These pins encroach upon the center of the c-channel. The purpose of these pins will be described in detail below.

An electronics board 17 provides a method to connect the USB cable connector 20 to the spring terminal connector 12 required to make a connection to the contact patches on the surface contact patch board 2. A commercially available USB male socket connector 20 is soldered into place on the backside of the electronics board 17. Conventional electrical traces manufactured into the electronics board 17 connect to a commercially available spring terminal connector 12, soldered on the front side of the electronics board.

The spring pins 13 on the above described spring pin connector 12 is centered vertically in the cable adapter housing. A formed steel cover plate 18 extends over the electronics board, providing protection for the electronics board while allowing the spring contact connector 12 to protrude towards the center of the cable adapter 15. A shaped slot located on the left hand side of the steel cover plate 18 allows the USB socket connector 20 to protrude to the edge of the cable adapter 15. Two screws are inserted into the countersunk holes 14 located in the front face of steel cover plate 18. These screws extend through the electronics board 17 and into threaded holes located on the back face of the c-channel. These screws serve to bind the assembly together and lock the electronics board into place.

FIG. 3 shows the current best method device for creating an electrical and mechanical connection between the surface contact patch board 2 and a host computer through the use of a standard USB cable (best shown in FIG. 5 as 21.). The host computer or computing device (i.e. handheld, laptop or desktop) powers the data memory module 9 through the USB cable 21 and the cable adapter 15. No battery is required. To connect the handcuff device to the host computer, the cable adapter is oriented so that the three alignment pins 10, 11, 16 in the cable adapter are aligned with the j-slots 6 in the central hub 1. The cable adapter 15 is pressed onto the central hub 1 with the alignment pins 10, 11, 16, guided by the first portion of the j-slots 6 (see FIGS. 3-5).

When the alignment pins 10, 11, 16 meet the back edge of the j-slots 6, the spring pin connector pins 13 are compressed against the front face of the contact patch board 2. The entire cable adapter 15 is slid axially to the left guided by the alignment pins 10, 11, and 16 moving in the axial portion of the j-slots 6. As the cable adapter 15 is slid axially to the left, the spring pins 13 in the spring pin connector 12 on the electronics board 17 make contact with the gold plated patches on the contact patch board 17. With the cable adapter 15 in its installed location on the central hub 1 as shown in FIG. 4, a standard USB data cable 21 is attached to the USB connector 20 on the electronics board 17. This USB cable 21 is then attached to the USB port on a computing device. This completes the electronic circuit between the computer and the memory storage module 9, allowing the computer to read and write data to the memory storage module 9. Once again, it may be possible to replace the USB connection with a wireless connection for reading and writing data from the memory storage module 9.

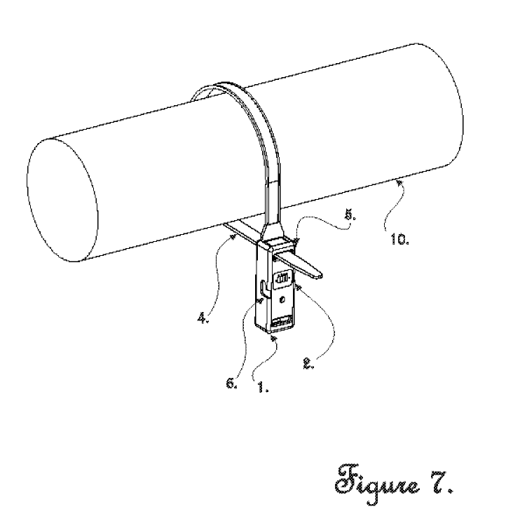

As shown in FIG. 7, the above-described device may be used with a single flexible restraint 4 to attach the device to an object 10 such as an item of evidence or as a replacement for a common tag style identification tag.

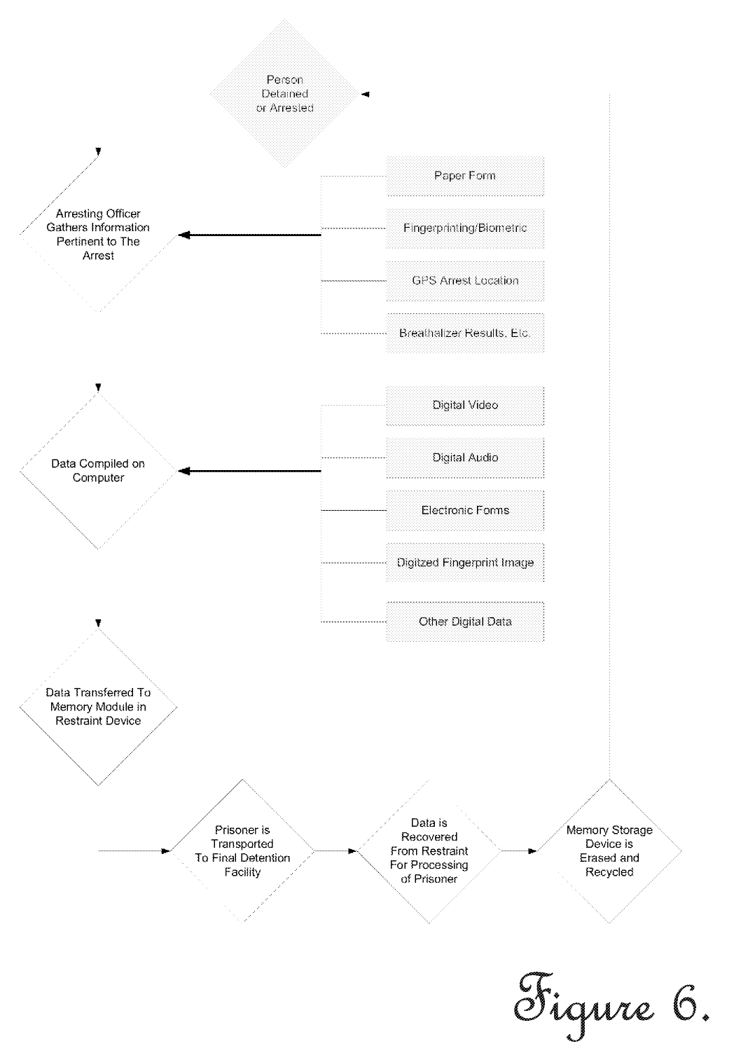

FIG. 6 demonstrates, through the use of a flowchart, the expected utilization of the device whereby the device is used to restrain an arrested individual, as well as provide a secure means for transporting digital data such as photographs, electronic forms, audio records and biometrics along with that arrested individual

As indicated in the above disclosure, the described invention provides a secure, reliable method for the transfer of data utilizing the restraint device that is placed on an individual who has been arrested. In addition, the integration of separable single cuffs into a double cuff system provides the users of the system with a distinct advantage during use in that the device is always attached to the arrested individual, even if one side of the restraint is removed. It is believed that the above-described invention will provide distinct advantages in the retention of arrest information as it is gathered in the field and during subsequent interviewing of the suspect as well as provide significant cost savings in the processing of information relating to the arrest and subsequent incarceration of an individual.

The foregoing description describes a single embodiment of the invention and is not intended to limit the scope of the patent right. It is probable that, as technology changes and improves, certain components or methods described above may be improved on, or evolve, without departing from the spirit and scope of the invention. The scope of the patent protection is to be limited in accordance with the applicable doctrines relating to patent interpretation and not limited by the specifics of the foregoing description.

1. A restraining device, comprising:
at least one flexible loop having a pawl end and a free end, the loop being closed by inserting the free end in and through a slot passageway in the pawl end, for making a fixed connection to the pawl end;
a connecting body having an opening shaped to receive the pawl end of the loop, the connecting body having an opening on opposite sides of the slot passageway in the pawl end, to define a passageway for the free end of the loop to pass through first one side of the connecting body, through the pawl end of the loop, and then out through an opposite side of the connecting body, to connect the loop to the connecting body when the loop is closed, with the connecting body further housing a data storage device for recording rewritable data, and still further, the connecting body having external electrical contacts that are connected to the data storage device for supplying power and transmitting data to and from the data storage device; and
a separate adaptor module. releasably connectable to the connecting body, for interfacing with the data storage device, wherein the adaptor module has electrical contacts that mate with the electrical contacts on the connecting body, for electrically connecting the adaptor module to the data storage device.

2. (canceled)

3. (canceled)

4. (canceled)

5. (canceled)

6. The restraining device of claim 1, wherein the adaptor module includes a USB port for connecting another device to the adaptor module.

7. The restraining device of claim 1, wherein the adaptor module includes means for communicating data to another device.
